(19) United States
(12) Patent Application Publication
(10) Pub. No.: US 2025/0099942 A1
(43) Pub. Date: Mar. 27, 2025

(54) CERIUM AND SAMARIUM CO-DOPED TIO2 NANOPARTICLES-BASED PHOTOCATALYTIC COMPOSITION FOR DYE DEGRADATION

(71) Applicant: Imam Abdulrahman Bin Faisal University, Dammam (SA)

(72) Inventors: Yassine SLIMANI, Dammam (SA); Munirah A. ALMESSIERE, Dammam (SA); Essia HANNACHI, Dammam (SA); Abdulhadi BAYKAL, Dammam (SA)

(73) Assignee: Imam Abdulrahman Bin Faisal University, Dammam (SA)

(21) Appl. No.: 18/475,702

(22) Filed: Sep. 27, 2023

(51) Int. Cl. B01J 21/06; B01J 23/10; B01J 35/00; B01J 35/08; C09B 11/24

(52) U.S. Cl. CPC B01J 21/063; B01J 23/10; B01J 35/23; B01J 35/39; B01J 35/393; B01J 35/51; C09B 11/24

(57) ABSTRACT

A photocatalytic nanoparticle composition includes titanium dioxide nanoparticles doped with cerium and samarium. The titanium dioxide nanoparticles have a tetragonal anatase crystal phase. The cerium and the samarium are each present in the titanium dioxide nanoparticles in an amount of 0.1 to 0.5% by weight based on a total weight of the titanium dioxide nanoparticles. The titanium dioxide nanoparticles have an average crystallite size of 15 to 16 nanometers (nm); and an average particle diameter of 21 to 23 nm. The photocatalytic nanoparticle composition used for dye degradation.

### STATEMENT REGARDING PRIOR DISCLOSURE BY THE INVENTORS

Aspects of the present disclosure were disclosed in an article titled “Synthesis of Ce and Sm/Co-Doped TiO₂ Nanoparticles with Enhanced Photocatalytic Activity for Rhodamine B Dye Degradation” published in Issue 4, Catalysts, which is incorporated herein by reference in its entirety.

### STATEMENT OF ACKNOWLEDGEMENT

The support provided by the Institute for Research and Medical Consultations (IMRC) of Imam Abdulrahman Bin Faisal University, Saudi Arabia, for providing laboratory facilities is gratefully acknowledged. The support provided by the King Fahd University of Petroleum and Minerals, Saudi Arabia, for providing laboratory facilities is gratefully acknowledged.

### BACKGROUND

### Technical Field

The present disclosure is directed to a photocatalytic nanoparticle composition, and particularly, to cerium and samarium co-doped TiO₂ nanoparticles-based photocatalytic composition for dye degradation.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Environmental pollution stemming from agricultural and industrial activities is becoming a major issue that threatens human life and other living beings. Indeed, the industrial spread has led to the appearance of toxic substances in nature, water, and soil, causing serious diseases. The presence of detectable quantities of numerous toxic organic contaminants and dyes in soil and marine environments has deteriorated the state of water sources in the world.

Since their inception, the textiles and dyes industries have substantially grown. As a consequence, greater discharge of synthetic dyes into water sources creates issues for aquatics and humans. Rhodamine B (RB) is a dye that is widely utilized in a variety of sectors, including foods and textiles; however, it is a toxic material that is mutagenic and carcinogenic to all living organisms. Additionally, RB is highly persistent and presents a major concern in the long term for aquatic species and plants since it obstructs light, reduces photosynthetic activity, and interferes with natural purification processes. RB should be eliminated from wastewater to prevent harmful impacts of its occurrence in the environment. The search for potent strategies that help to remove this environmental hazard should be pursued, especially when dealing with high concentrations of contaminants.

Traditional procedures for treating wastewater (biological, chemical, and physical routes) for the removal of dyes have drawbacks, including poor removal efficiency for resistant and nonbiodegradable organic dyes, the need for several post-treatment processes, and lengthy removal periods. In recent years, there has been interest in the use of advanced oxidation processes (AOPs) to purify contaminated wastewater. AOPs are distinguished by the generation of reactive oxygen species (ROS), such as singlet oxygen (O₂·), hydrogen peroxide (H₂O₂), hydroxyl radical (·OH), and superoxide radical (·O₂⁻), which is capable of rapidly oxidizing and degrading dye molecules found in industrial effluents. Sono catalysis, sonolysis, photocatalysis, photolysis, ozonation, and Fenton reaction are some examples of AOPs. Recently, nanomaterials endowed with effective photocatalytic activity have been considered as high-performing candidates for AOPs, making it possible to remove even trace amounts of pollutants from wastewater.

Several compounds, like TiO₂, ZnS, ZnO, CdS, and so on, have been classified as materials of high photocatalytic activity and gained attention for their use in water purification, healthcare, and food packaging. Of these photoactive materials, TiO₂ has been explored as a promising photocatalyst enabling both air and water pollution control, organic pollutants degradation, and fuel production from water and carbon dioxide. Abundance, cheapness, non-toxicity, and stability are among the advantages attendant to the use of TiO₂ as a semiconductor in photocatalysis, supercapacitors, solar energy conversion, and other fields of applications. TiO₂ exhibits properties beneficial for photocatalytic purposes, mainly a suitable redox ability, proper photo-response, and charge mobility. However, the catalytic performance of TiO₂ faces some obstacles related to the material's large bandgap (E_{g}=3.2 electron volt (eV)), principally including the quick recombination of photogenerated charge carriers and low interfacial charge-transfer rates. The use of this material oxide is restricted to the ultraviolet range with poor utilization of solar light for TiO₂ excitation.

For better photocatalytic efficiency, the light absorption range of TiO₂ photocatalysts should be extended to visible light. Investigations have been conducted to enhance the properties of TiO₂ either by controlling its morphology and crystal structure or by doping. Introducing defects in titanium (Ti) or oxygen (O) sites provides an effective way to reduce bandgap energy by forming new energy states and enhancing the photocatalytic response. The optoelectronic and catalytic properties for target applications as well as the creation of new energy states depend on the synthesis method and the choice of the dopant. Sol-gel, chemical vapor deposition, solvothermal, hydrothermal methods, hydrolysis, and the like are among the available synthesis routes of pristine and doped TiO₂ nanoparticles (NPs). The sol-gel method has proven to be the most beneficial due to its simplicity, low cost, accurate control of composition, purity, homogeneity, and so on.

Several reported results have shown that doping with rare earth (RE) ions such as Sm³⁺, Nd³⁺, Gd³⁺, Pr³⁺, Ce³⁺, and La³⁺ could notably enhance the photocatalytic activity of TiO₂. Due to their 4f orbital, which acts as electron acceptors when doped into TiO₂, these ions afford reliable sites for the adsorption of organic pollutants. They are also characterized by having large ionic radii, making it possible for their deposition on the surface of TiO₂ with a considerable increase of the surface area. Cerium (Ce) is one of the RE elements that has attracted interest as a TiO₂ doping agent due to its non-toxicity, cheapness, and its potential to boost the light-absorption capability of TiO₂. It has been demonstrated that an increase in Ce content leads to the tightening of the TiO₂ bandgap, and a clear redshift of the absorption has been observed. For instance, it has been shown that Ce-doped TiO₂ is a promising composite catalyst that enhances the degradation of methylene blue under visible light [Z. Xiu, Z. Xing, Z. Li, X. Wu, X. Yan, M. Hu, Y. Cao, S. Yang, W. Zhou, Ti3+-TiO₂/Ce³⁺-CeO₂ Nanosheet heterojunctions as efficient visible-light-driven photocatalysts, Mater. Res. Bull. 100 (2018) 191-197]. Likewise, samarium (Sm) has been widely applied to improve TiO₂-based photocatalysts. It has been shown that the incorporation of Sm into TiO₂ brings changes, particularly the reduction in particle size and the formation of discrete energy levels, which are reasons to avoid electron-hole pairs recombination [G. V. Khade, M. B. Suwarnkar, N. L. Gavade, K. M. Garadkar, Sol-gel microwave assisted synthesis of Sm-doped TiO₂ nanoparticles and their photocatalytic activity for the degradation of Methyl Orange under sunlight, J. Mater. Sci. Mater. Electron. 27 (2016) 6425-6432]. Sm-doped TiO₂ have been produced via sol-gel approach and reported to provide efficient photocatalytic activity because of the increase in the surface area and the improvement in visible light response [H. Peng, R. Guo, H. Lin, Photocatalytic reduction of CO₂ over Sm-doped TiO₂ nanoparticles, J. Rare Earths 38 (2020) 1297-1304, incorporated herein by reference in its entirety].

Although literature reveals investigations to develop modified TiO₂ photocatalysts either by doping or co-doping routes, there still exists a need to develop a photocatalytic composition with enhanced properties than those reported in the art. Accordingly, an object of the present disclosure is to provide cerium and samarium co-doped TiO₂ nanoparticles-based photocatalytic composition for dye degradation that can overcome limitations of the art.

### SUMMARY

In an exemplary embodiment, a photocatalytic nanoparticle composition is described. The photocatalytic composition includes titanium dioxide nanoparticles including cerium and samarium. The titanium dioxide nanoparticles have a tetragonal anatase crystal phase. The cerium and the samarium are each present in the titanium dioxide nanoparticles in an amount of 0.1 to 0.4% by weight based on a total weight of the titanium dioxide nanoparticles. The titanium dioxide nanoparticles have an average crystallite size of 15 to 16 nanometers (nm). The titanium dioxide nanoparticles have an average particle diameter of 21 to 23 nm.

In some embodiments, the titanium dioxide nanoparticles include oxygen in an amount of 67.5 to 68.5 at. %, titanium in an amount of 31 to 32 at. %, cerium in an amount of 0.1 to 0.4 at. %, and samarium in an amount of 0.1 to 0.4 at. % by weight based on a total atom count of the titanium dioxide nanoparticles.

In some embodiments, the cerium and the samarium are each present in the titanium dioxide nanoparticles in an amount of 0.1 to 2.5% by weight based on the total weight of the titanium dioxide nanoparticles. The nanoparticle composition has an average crystallite size of 15 to 18 nm. The nanoparticle composition has an average particle diameter of 18 to 25 nm. The titanium dioxide nanoparticles have a spherical shape.

In some embodiments, the titanium dioxide nanoparticles have a cell volume of 136.00 to 136.25 cubic angstrom (Å³).

In some embodiments, the cerium and the samarium displace the titanium in titanium dioxide crystallites.

In some embodiments, the titanium dioxide nanoparticles have an indirect bandgap (E_{g indirect}) from 3.05 to 3.15 electron volts (eV).

In some embodiments, the indirect bandgap is calculated from a plot of a square root of a Kubelka-Munk function multiplied by an energy of a photon ([(F(R)hν)]^{1/2}) versus an energy of a photon (hν).

In some embodiments, the titanium dioxide nanoparticles have a direct bandgap (E_{g direct}) from 3.15 to 3.25 eV.

In some embodiments, the direct bandgap is calculated from a plot of a square of a Kubelka-Munk function multiplied by an energy of a photon ([(F(R)hν)]²) versus an energy of a photon (hν).

In another exemplary embodiment, a method of dye degradation is disclosed. The method includes contacting the photocatalytic nanoparticle composition with a dye solution to form a mixture. The method further includes irradiating the mixture to degrade a dye in the dye solution.

In some embodiments, a reaction rate constant (k) under pseudo-first-order kinetics is from 0.0610 to 0.0620 per minute (min⁻¹). The reaction rate corresponds to a concentration based on an absorption spectrum of the degradation of the dye solution at various times of irradiation.

In some embodiments, the dye is a Rhodamine B dye.

In some embodiments, 97 to 99% of the dye in the dye solution is degraded during the irradiating. The percent is a concentration based on an absorption spectrum of the dye solution before and after the irradiating.

In some embodiments, the irradiating is from 1 to 30 minutes.

In some embodiments, the method includes irradiating the dye solution with light having a wavelength of 350 to 400 nm.

In some embodiments, the method includes contacting and irradiating the dye solution consecutively from 1 to 3 times and at least 94% of the dye in the dye solution is degraded. The percent is a concentration based on an absorption spectrum of the dye solution before and after the irradiation.

In some embodiments, the method further includes adding one or more scavengers to the mixture. The scavenger is at least one of isopropanol, ethylenediaminetetraacetic acid, a 1,4-benzoquinone, and silver nitrate.

In some embodiments, the mixture includes ethylenediaminetetraacetic acid and 40 to 50% of the ethylenediaminetetraacetic acid in the mixture is degraded during the irradiation. The percent is a concentration based on an absorption spectrum of the dye solution before and after the irradiating, wherein irradiating the mixture to degrade a dye in the dye solution forms holes in a valence band. The holes react with the ethylenediaminetetraacetic acid.

In some embodiments, the mixture includes 1,4-benzoquinone and 45 to 55% of the 1,4-benzoquinone in the mixture is degraded during the irradiation. The percent is a concentration based on an absorption spectrum of the dye solution before and after the irradiation. Irradiating the mixture degrades a dye in the dye solution and forms superoxide (·O₂⁻). The superoxide reacts with the 1,4-benzoquinone.

In some embodiments, the mixture comprises silver nitrate and 85 to 95% of the dye in the mixture is degraded during the irradiation. The percent is a concentration based on an absorption spectrum of the dye solution before and after the irradiation. The mixture comprises isopropanol and 80 to 90% of the dye in the mixture is degraded during the irradiation. The percent is a concentration based on an absorption spectrum of the dye solution before and after the irradiation.

These and other aspects of non-limiting embodiments of the present disclosure will become apparent to those skilled in the art upon review of the following description of specific non-limiting embodiments of the disclosure in conjunction with the accompanying drawings.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of the present disclosure (including alternatives and/or variation thereof) and many of the attendant advantages thereof will be readily obtained as the same becomes better understood by reference to the following detailed description when considered in connection with the accompanying drawings, wherein:

FIG. 1 is a schematic method flow chart for dye degradation using a photocatalytic nanoparticle composition, according to certain embodiments;

FIG. 2 depicts refined X-ray diffraction (XRD) patterns of cerium (Ce)-samarium (Sm) co-doped TiO₂ nanoparticles (NPs) (x=0.00, 0.25, 0.50, 1.00, and 2.00%), according to certain embodiments;

FIG. 3 depicts transmission electron microscopy (TEM) images for the Ce—Sm co-doped TiO₂ NPs (x=0, 0.25, 0.50, 1, and 2%), according to certain embodiments;

FIGS. 4A-4E depict histograms representing nanoparticles' size distribution of the Ce—Sm co-doped TiO₂ nanoparticles (x=0, 0.25, 0.50, 1, and 2%), respectively, according to certain embodiments;

FIG. 5 depicts elemental mapping images of x=1% photocatalytic nanoparticle composition of the Ce—Sm co-doped TiO₂ nanoparticles, according to certain embodiments;

FIG. 6 depicts a unit cell of the Ce—Sm co-doped TiO₂ nanomaterial composed of 72 atoms, according to certain embodiments;

FIG. 7A depicts density of states for pristine TiO₂ nanomaterial, according to certain embodiments;

FIG. 7B depicts the density of states for the Ce—Sm co-doped TiO₂ nanomaterial, according to certain embodiments;

FIG. 8A depicts F(R) plots of Ce—Sm co-doped TiO₂ samples, according to certain embodiments;

FIG. 8B depicts an enlarged view of the absorption edges of different compositions of FIG. 8A, according to certain embodiments;

FIG. 9A depicts determination of indirect bandgap of the Ce—Sm co-doped TiO₂ samples, according to certain embodiments;

FIG. 9B depicts evolutions in the indirect bandgap energies of TiO₂ versus Ce—Sm co-doping amounts, according to certain embodiments;

FIG. 9C depicts determination of direct bandgap of the Ce—Sm co-doped TiO₂ samples, according to certain embodiments;

FIG. 9D depicts evolutions in the direct bandgap energies of TiO₂ versus Ce—Sm co-doping amounts, according to certain embodiments;

FIGS. 10A-10F depict photocatalytic degradation of rhodamine B (RB) dyes of the Ce—Sm co-doped TiO₂ NPs (x=blank, 0.00, 0.25, 0.50, 1.00, and 2.00%), respectively, according to certain embodiments;

FIG. 11 depicts the degradation percentage (%) of RB dye against the different concentrations of the Ce—Sm co-doped TiO₂ NPs (x=0.00, 0.25, 0.50, 1.00, and 2.00%) after 30 minutes of visible light illumination, according to certain embodiments;

FIG. 12 depicts degradation of RB dyes with the time of the Ce—Sm co-doped TiO₂ NPs (x=0.00, 0.25, 0.50, 1.00, and 2.00%), according to certain embodiments;

FIG. 13 depicts kinetics simulation curve of the Ce—Sm co-doped TiO₂ NPs (x=0.00, 0.25, 0.50, 1.00, and 2.00%), according to certain embodiments;

FIG. 14 depicts recyclability of the Ce—Sm co-doped TiO₂ NPs with x=0.50%, according to certain embodiments;

FIG. 15 depicts effect of scavenger's test of the Ce—Sm co-doped TiO₂ NPs with x=0.50%, according to certain embodiments; and

FIG. 16 depicts a schematic illustration depicting a photocatalytic mechanism for Ce—Sm co-doped TiO₂ NPs, according to certain embodiments.

### DETAILED DESCRIPTION

In the following description, it is understood that other embodiments may be utilized and structural and operational changes may be made without departure from the scope of the present embodiments disclosed herein.

Reference will now be made in detail to specific embodiment or features, examples of which are illustrated in the accompanying drawings. Wherever possible, corresponding or similar reference numbers will be used throughout the drawings to refer to the same or corresponding parts. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to a photocatalytic nanoparticle composition. TiO₂ is an effective photocatalyst with a broad number of applications. To improve the photocatalytic activity of TiO₂, a series of cerium (Ce) and samarium (Sm) co-doped TiO₂ nanoparticles (x=0.00, 0.25, 0.50, 1.00, and 2.00%) were prepared via sol-gel auto-combustion approach. The influence of Ce—Sm concentrations on the structural, morphology, electronic, and optical properties, as well as the photocatalytic activity, are disclosed herein. Structure and elemental mapping analyses describe the presence of Ce and Sm in the compositions and the development of TiO₂ anatase phase with a tetragonal structure and crystallites size from 10 to 30 nm, preferably 12 to 25 nm, more preferably 14 to 20 nm, and yet more preferably 15 to 18 nm. Morphological observations show the creation of spherical nanoparticles (NPs). The examination of the electronic structure properties via density functional theory (DFT) calculations and the optical properties via UV-visible diffuse spectrophotometer showed a reduction in the bandgap energy upon Ce—Sm co-doping.

The photocatalytic activity of the photocatalytic nanoparticle composition was assessed for the degradation of Rhodamine B dye. As described herein, Ce—Sm co-doped TiO₂ nanoparticles have better photocatalytic activities over pristine TiO₂ nanoparticles. Among the prepared nanoparticles, the sample with x=0.50% demonstrated the best photocatalytic activity with a degradation efficiency of 98% of an initial sample within 30 minutes and a reaction rate constant of about 0.0616 min⁻¹. Holes (h⁺) and ·O₂⁻ were determined to be active species in the photocatalytic degradation process. In addition to the high photocatalytic degradation efficiency, the photocatalysts of the present disclosure are stable and may be recovered and reused, which indicates potential for practical applications in the future.

According to an aspect of the present disclosure, a photocatalytic nanoparticle composition is described. The photocatalytic composition includes titanium dioxide nanoparticles including cerium and samarium. The titanium dioxide nanoparticles include oxygen in an amount of 65 to 70 at. %, preferably 67 to 69 at. %, and more preferably 67.5 to 68.5 at. % titanium in an amount of 30 to 35 at. %, preferably 30 to 33 at. %, and more preferably 31 to 32%, cerium in an amount of 0.1 to 2.0 at. %, preferably 0.2 to 1.0, and more preferably 0.3 to 0.5 at. %, and samarium in an amount of 0.1 to 2.0 at. %, preferably 0.2 to 1.5 at. %, 0.3 to 1.0 at. %, and more preferably 0.5 to 0.7 at. % based on a total atom count of the titanium dioxide nanoparticles. In a preferred embodiment, the titanium dioxide nanoparticles include samarium is in an amount of 0.1 to 0.3% by weight based on a total weight of the titanium dioxide nanoparticles. The titanium dioxide nanoparticles may exist in different phases, rutile, anatase, and brookite phase, preferably, anatase. In a preferred embodiment, the titanium dioxide nanoparticles have a tetragonal anatase crystal phase.

The titanium dioxide nanoparticles may exist in various shapes such as spheres, spheroids, lentoids, ovoids, solid polyhedral such as tetrahedra, cubes, octahedra, icosahedra, dodecahedra, hollow polyhedral (also known as nanocages), stellated polyhedral (both regular and irregular, also known as nanostars), triangular prisms (also known as nanotriangles), hollow spherical shells (also known as nanoshells), tubes (also known as nanotubes), nanosheets, nanoplates, nanodisks, rods (also known as nanorods), and mixtures thereof. The titanium dioxide nanoparticles may be amorphous, polycrystalline, or crystalline, preferably crystalline. In a preferred embodiment, the titanium dioxide nanoparticles have a spherical morphology. An advantage of a spherical shape is that spheres possess minimum surface area amongst all geometric shapes. Moreover, spherical shapes promote minimum possible state of energy in existence. The geometry of the titanium dioxide nanoparticles may include, but are not limited to, spherical, circular, polygonal, triangular, and rectangular.

The titanium dioxide nanoparticles have a cell volume of 136.00 to 137.00 cubic angstrom (Å³), preferably 136.00 to 136.50 Å³, preferably 136.00 to 136.25 Å³, preferably 136.05 to 136.20 Å³, more preferably 136.10 to 136.15 Å³, and yet more preferably 136.10 to 136.12 Å³. Alternately, the cerium and the samarium are each present in the titanium dioxide nanoparticles in an amount of 0.1 to 2.5%, preferably 0.1 to 2.0%, more preferably 0.2 to 1.0%, and yet more preferably about 0.5% by weight based on the total weight of the titanium dioxide nanoparticles. The cerium and the samarium displace the titanium in titanium dioxide crystallites. The titanium dioxide nanoparticles have an average crystallite size from 10 to 30 nm, preferably 12 to 25 nm, more preferably 14 to 20 nm, more preferably 15 to 18 nm, 15 to 18 nm, more preferably 15 to 17 nm, and yet more preferably 15 to 16 nm. The titanium dioxide nanoparticles have an average particle diameter of 10 to 50 nm, preferably 15 to 30 nm, preferably 18 to 25 nm, preferably 19 to 24 nm, preferably 20 to 23 nm, more preferably 21 to 23 nm, and yet more preferably about 22 nm. In a preferred embodiment, the titanium dioxide nanoparticles have an average crystallite size of 15 to 16 nm, and an average particle diameter of 21 to 23 nm. In an embodiment, the photocatalytic nanoparticle composition comprises a homogeneous size distribution of the titanium dioxide nanoparticles.

The titanium dioxide nanoparticles have an indirect bandgap (E_{g indirect}) from 3.05 to 3.15 electron volts (eV), preferably 3.10 to 3.14 eV, more preferably 3.11 to 3.13 eV, and yet more preferably about 3.12 eV. The indirect bandgap is calculated from a plot of a square root of a Kubelka-Munk function multiplied by an energy of a photon ([(F(R)hν)]^{1/2}) versus an energy of a photon (hν). The titanium dioxide nanoparticles have a direct bandgap (E_{g direct}) from 3.15 to 3.25 eV, preferably 3.17 to 3.23 eV, more preferably 3.19 to 3.22 eV, and yet more preferably about 3.21 eV. The direct bandgap is calculated from a plot of a square of a Kubelka-Munk function multiplied by an energy of a photon ([(F(R)hν)]²) versus an energy of a photon (hν).

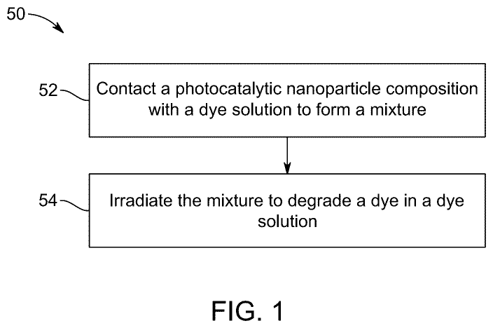

FIG. 1 illustrates a flow chart of a method 50 for dye degradation. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting a photocatalytic nanoparticle composition with a dye solution to form a mixture. In an embodiment, the photocatalytic nanoparticle is made to contact the dye solution for a sufficient period. In a preferred embodiment, the photocatalytic nanoparticle composition is the titanium dioxide nanoparticles of the present disclosure. The dye is preferably Rhodamine B. In some embodiments, the dye may include acid dyes, natural dyes, basic (cationic) dyes, synthetic dyes, direct (substantive) dyes, disperse dyes, sulfur dyes, pigment dyes, mordant dyes, vat dyes, reactive dyes, macromolecular dyes, metallized dyes, naphthol dyes, premetallized dyes, gel dyeing, developed dyes, azo dyes, aniline dyes, anthraquinone dyes, the like, and a mixture thereof.

The method 50 further includes adding one or more scavengers to the mixture. The scavenger may be an electron scavenger, a proton scavenger, a hole scavenger, a hydroxyl radical (·OH) scavenger, a superoxide radical (·O₂⁻) scavenger, and the like. The scavenger may react with dye degradation products. The scavenger may be silver nitrate (AgNO₃), carbon tetrachloride (CCl₄), potassium dichromate (K₂Cr₂O₇), potassium iodide (KI), an ethylenediaminetetraacetic acid, a triethanolamine, ammonium oxalate, sodium oxalate (Na₂C₂O₄), an oxalate, methanol, ascorbic acid, formic acid, tert-butyl alcohol, 2-propanol, benzoquinone, acrylamide, superoxide dismutase, an azide, and the like. In a preferred embodiment, the scavenger is at least one of isopropanol, ethylenediaminetetraacetic acid, a 1,4-benzoquinone, and silver nitrate.

At step 54, the method 50 includes irradiating the mixture to degrade a dye in the dye solution. During irradiation, at least 50%, preferably at least 60%, preferably at least 70%, more preferably at least 80%, or more preferably at least 90%, or more preferably at least 95%, and yet more preferably at least 97 to 99% of the dye in the dye solution is degraded during irradiation. A degree of dye degradation is calculated as a percent of an initial concentration of the dye in the dye solution. The percent is calculated from a concentration derived, using the Beer-Lambert law, from the absorption spectral data at a wavelength of 554 nm of the dye solution before irradiation (initial concentration) and the concentration derived from the absorption spectral data at 554 nm of the dye solution after the irradiation (final concentration). In some embodiments, an irradiation source may be a xenon lamp with a power of 200 to 300 watt (W), preferably about 250 W. A reaction rate constant (k) under pseudo-first-order kinetics is from 0.0300 to 0.0700 per minute (min⁻¹), preferably 0.0400 to 0.0650 min⁻¹, preferably 0.0550 to 0.0630 min⁻¹, more preferably 0.0610 to 0.0620 min⁻¹, and yet more preferably about 0.0616 min⁻¹. The reaction rate corresponds to a concentration based on an absorption spectrum of the degradation of the dye solution at various times of irradiation. The irradiation is from 1 to 90 minutes, preferably 1 to 60 minutes, and more preferably 1 to 30 minutes. In an embodiment, the irradiation is performed with visible light. In some embodiments, the irradiation includes irradiating the dye solution with light having a wavelength of 200 to 800 nanometers, preferably 350 to 750 nm, more preferably 350 to 500 nm, and yet more preferably 350 to 400 nm. In an embodiment, the contacting and irradiating occur consecutively from 1 to 3 times and at least 94% of the dye in the dye solution is degraded. The percent is a concentration based on an absorption spectrum of the dye solution before and after the irradiation.

In some embodiments, the mixture includes ethylenediaminetetraacetic acid and 30 to 60%, preferably 0 to 50%, more preferably 45 to 50% of the ethylenediaminetetraacetic acid in the mixture is degraded during the irradiation. The percent is a concentration based on an absorption spectrum of the dye solution before and after the irradiation. Irradiating the mixture to degrade a dye in the dye solution results in forming holes in a valence band. The ethylenediaminetetraacetic acid scavenges and blocks the holes in the valance band. In some embodiments, the mixture includes 1,4-benzoquinone and 35 to 65%, preferably 45 to 55%, more preferably 50 to 55% of the 1,4-benzoquinone in the mixture is degraded during the irradiation. The percent is a concentration based on an absorption spectrum of the dye solution before and after the irradiation. Irradiating the mixture to degrade a dye in the dye solution forms a superoxide radical (·O₂⁻). The superoxide radical reacts with the 1,4-benzoquinone.

### EXAMPLES

The following examples describe and demonstrate exemplary embodiments of the photocatalytic nanoparticle composition herein. The examples are provided solely for the purpose of illustration and are not to be construed as limitations of the present disclosure, as many variations thereof are possible without departing from the spirit and scope of the present disclosure. Materials

The chemicals titanium(IV) isopropoxide (C₁₂H₂₈O₄Ti; 98%; ThermoFisher Scientific), cerium(III) nitrate hexahydrate (Ce(NO₃)₃·6H₂O; 99.99%; Loba Chemie), samarium(III) nitrate hexahydrate (Sm(NO₃)₃·6H₂O; 99.9%; Sigma Aldrich), citric acid (C₆H₈O₇; 99+%; Aldrich), ammonium hydroxide solution (NH₄OH), and absolute ethanol (CH₃CH₂OH) were used as raw materials without further purification.

### Synthesis of Pristine and Ce—Sm Co-Doped TiO₂ NPs

Pristine TiO₂ and Ce—Sm co-doped TiO₂ NPs were prepared via sol-gel auto-combustion approach. The procedure could be described as follows. An appropriate amount of titanium isopropoxide was dissolved in a beaker containing an ethanolic solution and citric acid mixture under vigorous stirring. In other beakers, appropriate amounts of rare-earth-based nitrates of Ce and Sm were dissolved in deionized water under stirring. The amounts of doped Sm³⁺ and Ce³⁺ ions are x=0.00, 0.25, 0.50, 1.00, and 2.00%. After a while, different solutions were mixed into one beaker and left under continuous stirring for 2 hours. Then, the pH value was adjusted to about 6-7 with ammonia. Some amount of water was evaporated by heating the solution above the hot plate at a temperature of about 80° C. for 3 hours. Under continuous stirring and heating, a precursor gel will be gradually created. Later, the temperature was raised to about 150° C. for 30 minutes and then to about 280° C. until the sample is auto-ignited. The obtained as-combusted powders were finely ground in an agate mortar and then transferred for calcination at 500° C. for 2 hours in a furnace. TiO₂ nanoparticles co-doped with different concentrations of Ce—Sm ions (x=0.00, 0.25, 0.50, 1.00, and 2.00%) were finally obtained.

### Characterization Techniques

The crystalline phases of prepared NPs were studied by a Rigaku miniflex benchtop X-ray diffractometer (manufactured by Rigaku, Japan) (Cu Kα radiation of λ=1.5406 Å) with a scan rate of 0.02° per second. The values of crystallite size (D_{XRD}) were estimated from XRD patterns by applying the Scherrer equation [E. Hannachi, M. A. Almessiere, Y. Slimani, A. Baykal, F. Ben Azzouz, A C susceptibility investigation of YBCO superconductor added by carbon nanotubes, J. Alloys Compd. 812 (2020) 152150, incorporated herein by reference in its entirety]:

$${D}_{XRD} = \frac{K λ}{βcos θ} \qquad ( 1 )$$

where λ is the wavelength of X-rays, K is a constant (˜0.94), θ is the diffraction angle, and β is the full width at half maximum (FWHM). The morphology and size of prepared products were observed by transmission electron microscopy (TEM, Model FEI, Morgagni 268, Czech Republic). The chemical composition by elemental mapping was determined by energy dispersive X-ray spectrometry (EDXS) coupled with scanning electron microscopy (SEM, Tescan Vega 3, Czech Republic). To investigate the electronic properties, the density functional theory (DFT) calculations were accomplished by QuantumATK software.

The optical properties were studied in a wavelength interval of 200-800 nm by means of an ultraviolet-visible (UV-vis) spectrophotometer (JASCO V-750, 28600 Mary's Court, Easton, MD 21601). The values of band gap energy (E_{g}) can be estimated by using Kubelka-Munk function F(R) and Tauc plots:

$$F ( R ) = α = \frac{( 1 - R )}{2 R} \qquad ( 2 )$$

$$α hv = {α ( hv - {E}_{g} )}^{n} \qquad ( 3 )$$

where R is the reflectance, ν is the frequency, h is the Planck constant, hν is photon energy, and α is a constant representing the absorption coefficient. The exponent n specifies the nature of optical transition, whereas n=1/2 and n=2 represent direct and indirect band gaps, respectively. Hence, by plotting [F(R)hν]² against hν and [F(R)hν]^{1/2} against hν (called Tauc plots), the values of E_{g, direct} and E_{g, indirect}, respectively, can be determined.

### Photocatalytic Activity Experiments

The photocatalytic degradation of Rhodamine B (RB) dye was performed under irradiation of visible light sources in the presence of nanocatalysts. An amount of the nanocatalyst was dispersed in a solution containing 50 milliliters (mL) of RB (10 parts per million (ppm)) dye. Before light illumination (dark condition), the mixture was constantly stirred for 30 minutes above the magnetic stirrer to get an adsorption/desorption equilibrium in the existence of the nanocatalyst. Then, the solution mixture was irradiated with visible light (250 W, Xenon lamp with a cutoff filter of λ≤400 nm) for 30 minutes. Throughout the experiments, 2 mL of this solution was collected, and the concentration of RB dye at a wavelength of 554 nm was determined using a UV-vis JASCO V-750 spectrophotometer and an examination of the absorption spectra in the wavelength range from 400 to 700 nm, respectively. The following equation was used to calculate the degradation efficiency of the dye [M. George, T. L. Ajeesha, A. Manikandan, A. Anantharaman, R. S. Jansi, E. R. Kumar, Y. Slimani, M. A. Almessiere, A. Baykal, Evaluation of Cu—MgFe₂O₄ spinel nanoparticles for photocatalytic and antimicrobial activates, J. Phys. Chem. Solids 153 (2021) 110010, incorporated herein by reference in its entirety]:

$$Degradation efficiency \% = ( {C}_{0} - C / {C}_{0} ) \times 100 \qquad ( 4 )$$

where C₀ (in milligram per liter (mg L⁻¹)) is the initial RB dye concentration and C (in mg L⁻¹) is the residual concentration of RB dye.

The kinetics assessment of RB elimination tended to follow pseudo-first-order kinetics. The following equation was used to calculate the photodecomposition rate (k) constant [A. Dinesh, K. Kanmani Raja, A. Manikandan, M. A. Almessiere, Y. Slimani, A. Baykal, H. S. Alorfi, M. A. Hussein, A. Khan, Sol-gel combustion synthesis and photocatalytic dye degradation studies of rare earth element Ce substituted Mn—Zn ferrite nanoparticles, J. Mater. Res. Tech. 18 (2022) 5280-5289, incorporated herein by reference in its entirety]:

$$ln ( {C}_{0} / C ) = kt \qquad ( 5 )$$

To assess the stability of the photocatalyst, the degradation experiment was repeated for up to 3 cycles in the same environment. The photocatalyst was separated after each degradation test by washing and filtering the solution for the next photocatalytic activity test.

In addition, to determine the reactive oxygen species (ROS) of the photocatalytic activity, trapping experiments were carried out using various radical scavengers like isopropanol (IPA, 10 millimolar (mM)), ethylenediaminetetraacetic acid (EDTA, 10 mM), 1,4-benzoquinone (BQ, 1 mM), and silver nitrate (AgNO₃, 10 mM) which acted as the scavengers for hydroxyl radicals (·OH), holes (h⁺), superoxide radicals (·O₂⁻) and electrons (e⁻), respectively.

### Phase Analysis

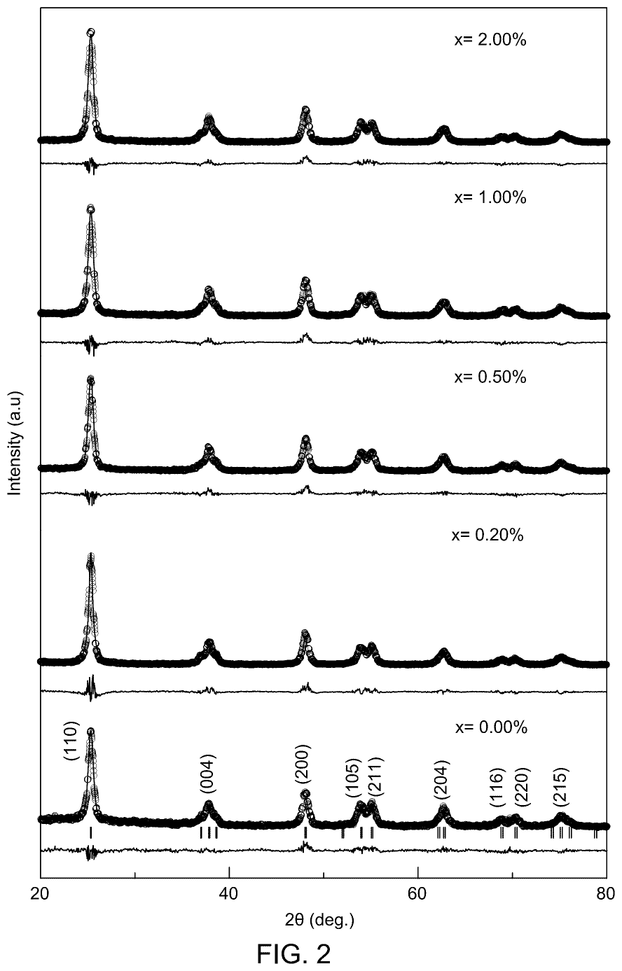

X-ray powder diffraction patterns of the prepared Ce—Sm co-doped TiO₂ NPs (x=0.00, 0.25, 0.50, 1.00, and 2.00%) are presented in FIG. 2. The pure and Ce—Sm co-doped TiO₂ NPs exhibited diffraction peaks at about 25.33°, 37.84°, 48.06°, 53.96°, 55.11°, 62.69°, 68.89°, 70.34°, and 75.15°, which are associated to crystal planes (1 1 0), (0 0 4), (2 0 0), (1 0 5), (2 1 1), (2 0 4), (1 1 6), (2 2 0), and (2 1 5), respectively. All these peaks correspond to the anatase phase of tetragonal TiO₂ without the detection of any undesired phase, which approved the incorporation of Ce and Sm ions within the anatase crystal lattice. Furthermore, no other peaks belonging to brookite or rutile TiO₂ phases are detected. The XRD patterns also showed high-intensity peaks, which indicated the crystalline nature of TiO₂ NPs. The formation of the anatase TiO₂ phase was approved through Rietveld refinement of experimental XRD data by utilizing Match 3 and Fullproof software, as shown in FIG. 2.

The calculated structural parameters and average crystallite size (D_{XRD}) are presented in Table 1. The structural parameters a=b and c, which are generally influenced by the dissimilarity in ionic radii of different cations, the impurity atoms, the defects, and the like, varied with Ce—Sm co-doping [R. Chauhan, A. Kumar, R. P. Chaudhary, Structural and optical characterization of Zn doped TiO^{2¬} nanoparticles prepared by sol-gel method, J. Sol-Gel Sci. Technol. 61 (2012) 585-591, incorporated herein by reference in its entirety]. This would generate a distortion in the lattice structure. The calculated D_{XRD} values were found in the range of 17.8-15.1 nm. The crystallite size of TiO₂ NPs slightly decreases with increasing the concentration of Ce—Sm co-dopants. This could be ascribed to the inhibition in the growth of TiO₂ nanocrystallites by the adsorptions of Ce and Sm ions when increasing the concentration of Ce—Sm co-dopants [D. Tsotetsi, M. Dhlamini, P. Mbule, Sol-gel synthesis and characterization of Ho³⁺ doped TiO₂ nanoparticles: Evaluation of absorption efficiency and electrical conductivity for possible application in perovskite solar cells, Opt. Mater. 130 (2022) 112569, incorporated herein by reference in its entirety].

TABLE 1
Refined structural parameters of Ce—Sm doped
TiO₂ NPs (x = 0.00, 0.25, 0.50, 1.00, and 2.00%).

| x (%) | a = b (Å) | c (Å) | V (Å³) | D_{XRD} (nm) | R_{Bragg} | χ² (chi²) |
|---|---|---|---|---|---|---|
| 0.00 | 3.7856 | 9.5034 | 136.19 | 17.8 | 11.3 | 1.3 |
| 0.25 | 3.7853 | 9.5036 | 136.17 | 16.6 | 22.3 | 4.4 |
| 0.50 | 3.7846 | 9.5027 | 136.11 | 15.7 | 26.0 | 3.7 |
| 1.00 | 3.7851 | 9.4974 | 136.06 | 15.5 | 23.4 | 3.4 |
| 2.00 | 3.7856 | 9.5035 | 136.19 | 15.1 | 23.6 | 3.8 |

### Morphological Observations

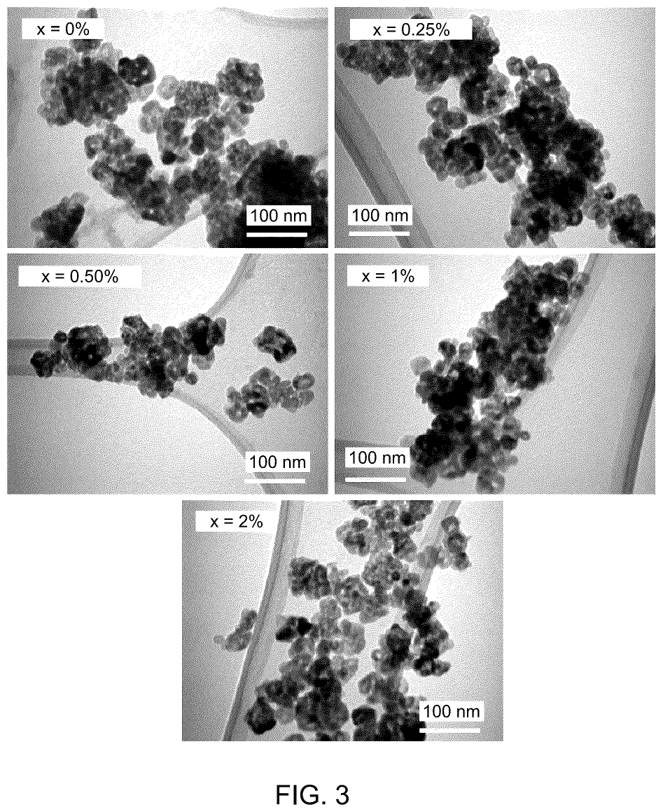

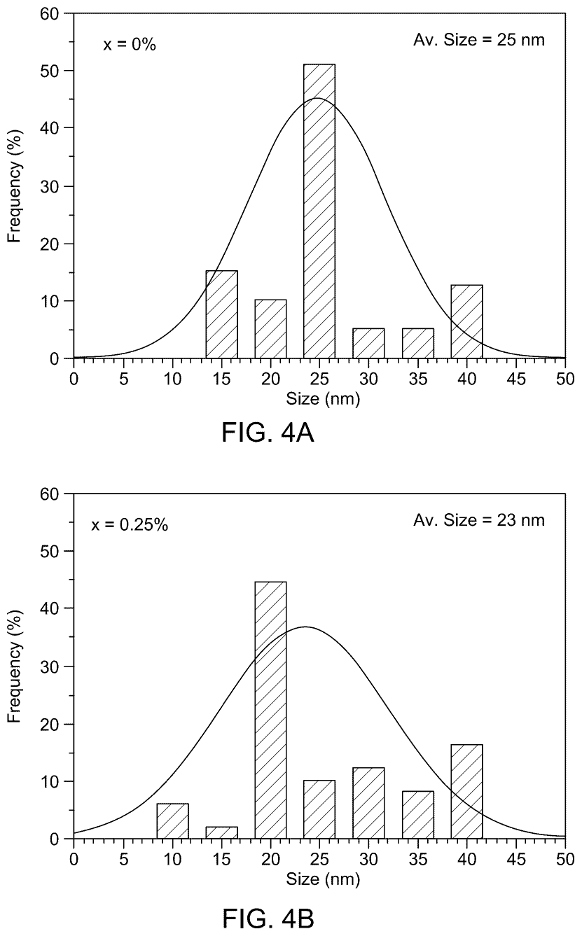

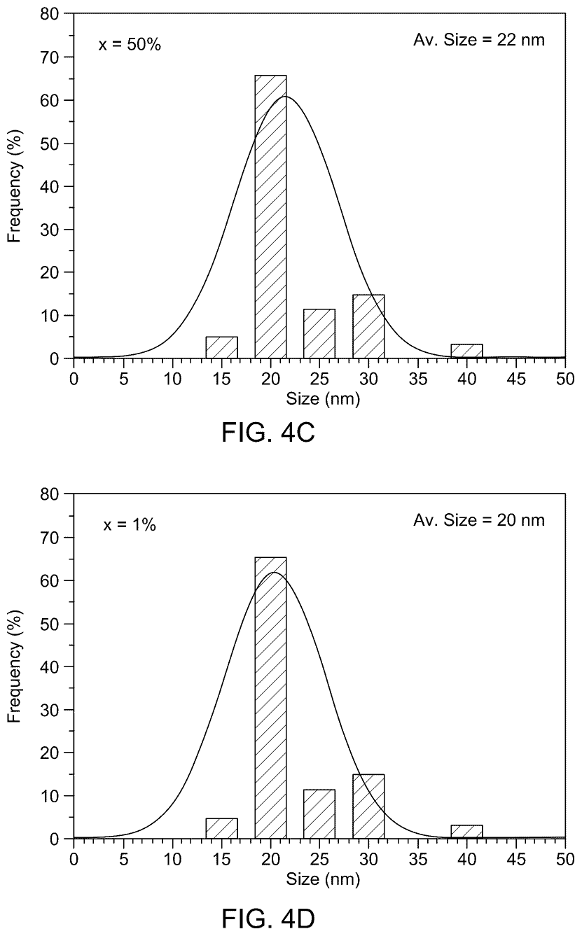

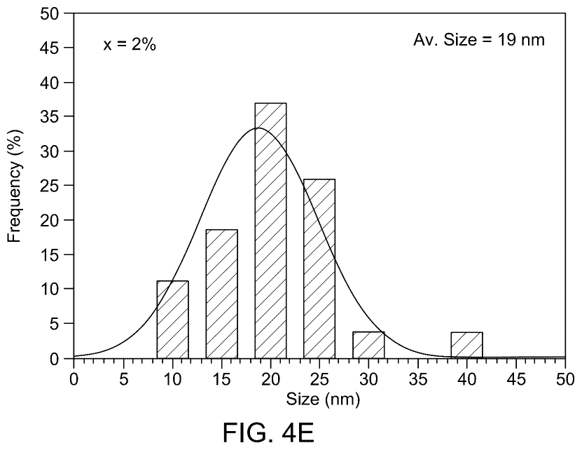

TEM is a valuable technique to assess the size and morphology of nanoparticles. FIG. 3 and FIGS. 4A-4E present the TEM images and size distribution histograms of the pure and Ce—Sm co-doped TiO₂ NPs (x=0.00, 0.25, 0.50, 1.00, and 2.00%), respectively. These images indicate spherical nanoparticles with an average particle diameter in the interval of 19-25 nm. The median diameter of the nanoparticles is slightly reduced from 25 nm to about 19 nm with the inclusion of Ce and Sm ions. Furthermore, the obtained results indicated a well-homogenous size distribution for each prepared composition. The obtained findings are in good agreement with the above XRD analyses.

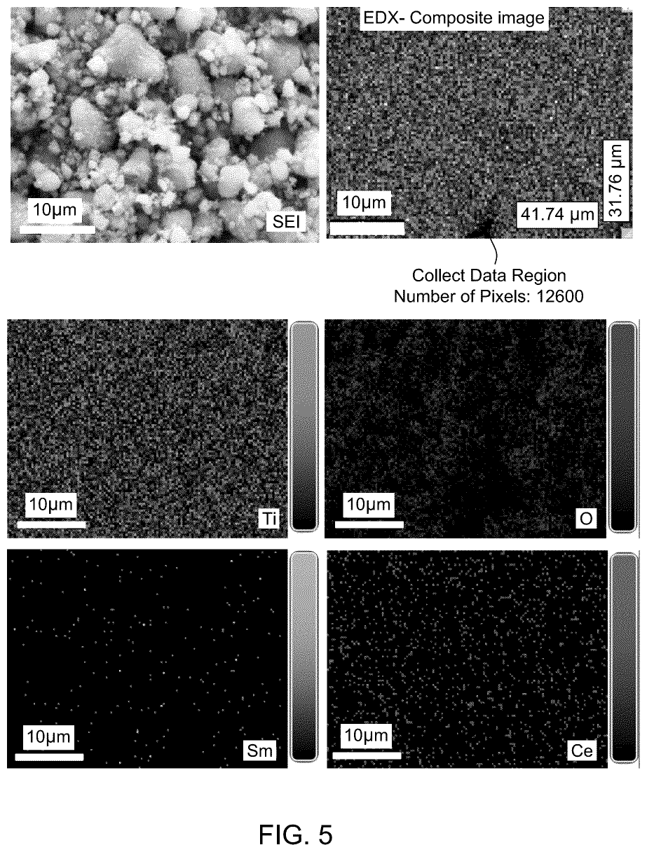

FIG. 5 displays the elemental mapping of TiO₂ nanoparticles co-added with an x content of 1% of Ce and Sm ions. FIG. 5 clearly shows the presence of Ti, Ce, Sm, and O elements, which are uniformly distributed in the sample. The atomic percentages for O, Ti, Ce, and Sm elements are about 67.87%, 31.44%, 0.39%, and 0.30%, respectively.

### Electronic Structure Properties

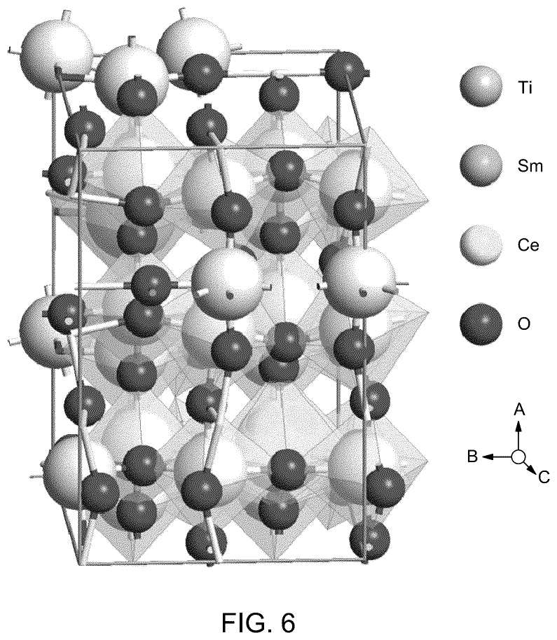

Exhibiting the electronic structure characteristics plays a role in the understanding of experimental findings. They are related to the absorption mechanism and accompanying catalytic activity. Density functional theory (DFT) is an appropriate tool to reveal the electronic structure and band gap of nanomaterials. In this context, the combination of experiments and the DFT study provides a better understanding of the mechanisms behind RB dye removal [Y. E Ouardi, A. E. Aissouq, A. Chennah, A. Ouammou, K. Laatikainen, Synthesis, characterization, and DFT investigation of rhodamine B dye removal by activated carbon produced from argan nutshell, Biomass Conv. Bioref. (2022), incorporated herein by reference in its entirety]. By employing density functional theory (DFT), numerical calculations were performed to unveil the effect of Sm and Ce co-doping on the electronic structure properties of TiO₂. To this end, DFT-based QuantumATK software is employed for the Sm and Ce co-doped TiO₂. Its unit cell, composed of 72 atoms (22 Ti, 1 Sm, 1 Ce, and 48 O atoms), is illustrated in FIG. 6. The number of dopants employed in the unit cell shows 2.8% co-doped NPs. This content is higher than the maximum dopant amount (2.0%) used in the experimental work. The TiO₂'s unit cell (given by lattice parameters a=11.41 Å, b=7.61 Å, c=9.75 Å), upon replacing the two Ti atoms by Sm and Ce, is obtained by setting a force tolerance of 0.01 eV/Å. Next, DFT calculations are implemented using spin-dependent generalized gradient approximation (SGGA+U) with Perdew-Burke-Ernzerhof (PBE) functional (SGGAU.PBE) [J. P. Perdew, K. Burke, M. Ernzerhof, generalized gradient approximation made simple, Phys. Rev. Lett. 77 (1996) 3865-3868, incorporated herein by reference in its entirety] for the exchange and correlation effects of the electrons.

Here, U is the Hubbard term providing a band gap correction to the DFT approximation. In this way, the hybridization of rare earth (RE)-4f and Ti-3d atoms can be described properly. The U term is set to 8.5, 1.5, and 1.5 eV for Ti-3d, Sm-4f, and Ce-4f electrons, respectively [V. Ney, S. Ye, T. Kammermeier, K. Ollefs, F. Wilhelm, A. Rogalev, S. Lebègue, A. L. da Rosa, A. Ney, Structural and magnetic analysis of epitaxial films of Gd-doped ZnO, Phys. Rev. B 85 (2012) 235203; and S. Fabris, S. de Gironcoli, S. Baroni, G. Vicario, G. Balducci, Taming multiple valency with density functionals: A case study of defective ceria, Phys. Rev. B 71 (2005) 041102(R), both of which are incorporated herein by reference in their entireties]. For the ion cores, PseudoDojo pseudopotentials are utilized. Ti, Sm, Ce, and O atoms are identified by their valence electrons; Ti: 4s²3d², Sm: 6s²4f⁶, Ce: 6s²5d¹4f¹, O: 2s²2p⁴. A mesh cutoff energy of 125 Hartree with (3,4,3) k-point mesh within the Monkhorst-Pack scheme is employed.

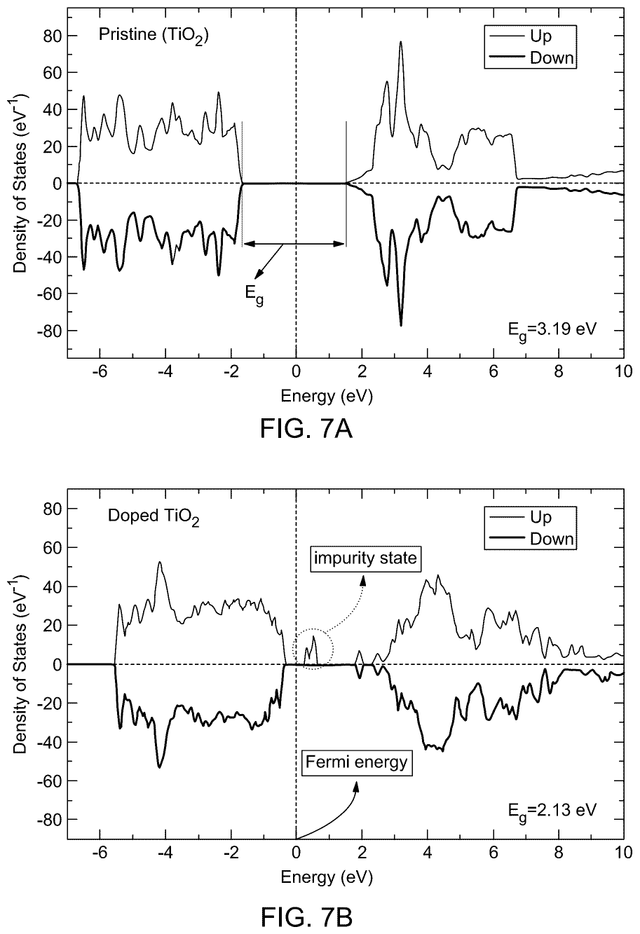

The total density of states (DOS) for both pristine TiO₂ and Ce—Sm co-doped TiO₂ NPs are illustrated in FIG. 7A and FIG. 7B, respectively, where the Fermi energy (E_{F}) is adjusted to zero. The DOS spectra, providing information about the electronics structure, demonstrate that spin-up (positive variation) and spin-down (negative variation) states are identical. Ce and Sm atoms bring about additional states around the E_{F}, modifying the Ce—Sm co-doped TiO₂'s electronic structure properties. It indicates that electronic characteristics can be tuned by the addition of rare earth metal atoms, resulting in the alteration of the energy bandgap (E_{g}). Using the difference between the valence band maximum (negative energy) and conduction band minimum (positive energy), the energy bandgap can be obtained from the DOS spectra as shown in FIG. 7A. The TiO₂'s E_{g} is calculated as 3.19 eV. Upon addition of Ce—Sm dopants, the E_{g} decreases to 2.13 eV, and impurity states emerge, as displayed in FIG. 7B. Such a drop in E_{g} is reasonable as it was reported to be 2.20 eV in experimental work for the Ce-doped TiO₂ nanocrystals where Ce concentration was 10% [A. Jafari, S. Khademi, M. Farahmandjou, A. Darudi, R. Rasuli, Structural and Optical Properties of Ce³⁺-Doped TiO₂ Nanocrystals Prepared by Sol-Gel Precursors, J. Electron. Mater. 47 (2018) 6901, incorporated herein by reference in its entirety]. The energy bandgap could be ascribed to factors like modification of unit cell (provoking a change in lattice parameters) and new available states in the vicinity of E_{F} (which lowers the band gap) due to the incorporation of rare earth metal ions.

### Optical Investigation

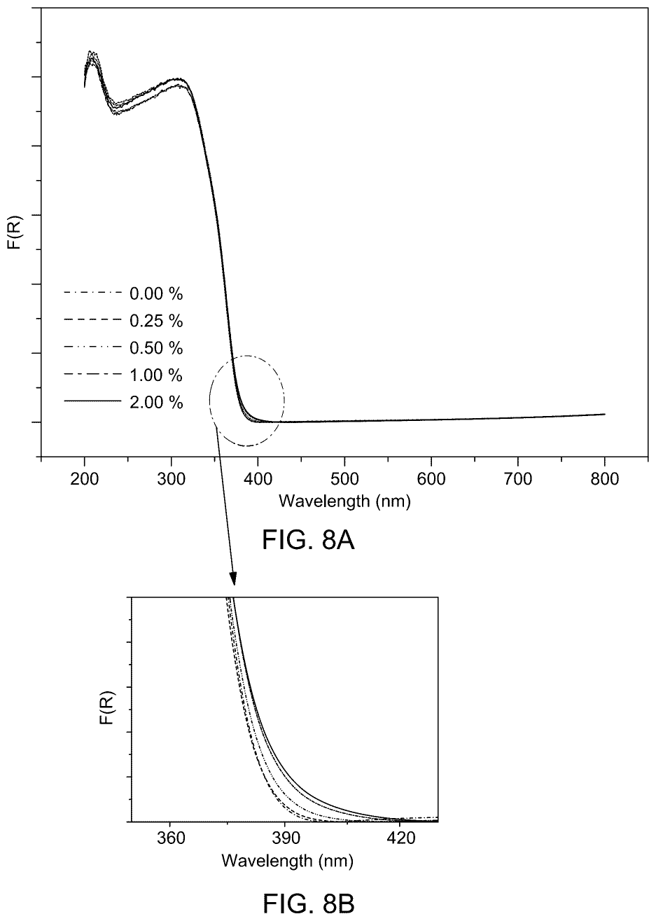

The impact of Ce—Sm co-doping on the UV-visible spectra of TiO₂ NPs is studied in a wavelength range of 200-800 nm. The spectra were registered in reflectance mode. From these spectra, F(R) plots are determined by employing Kubelka-Munk (KM) function, F(R)=(1−R)²/2R. The spectra display almost similar curves shape (FIGS. 8A-8B). There is no notable variation in the absorption peak position of TiO₂ NPs on co-doping. The inset displays the enlarged sight of absorption edges for all compositions. The absorption edge is slightly red-shifted when the concentration of cerium and samarium increases.

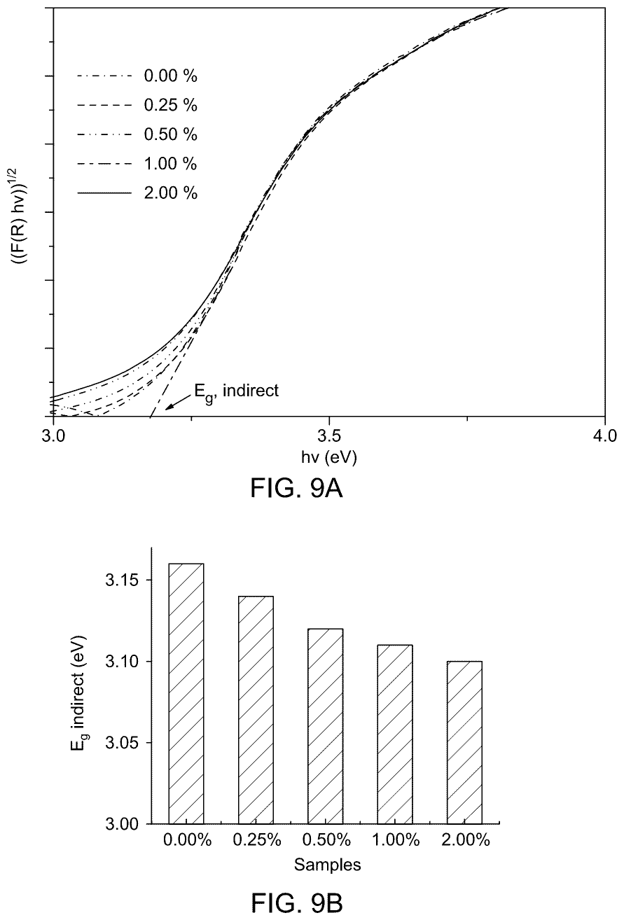

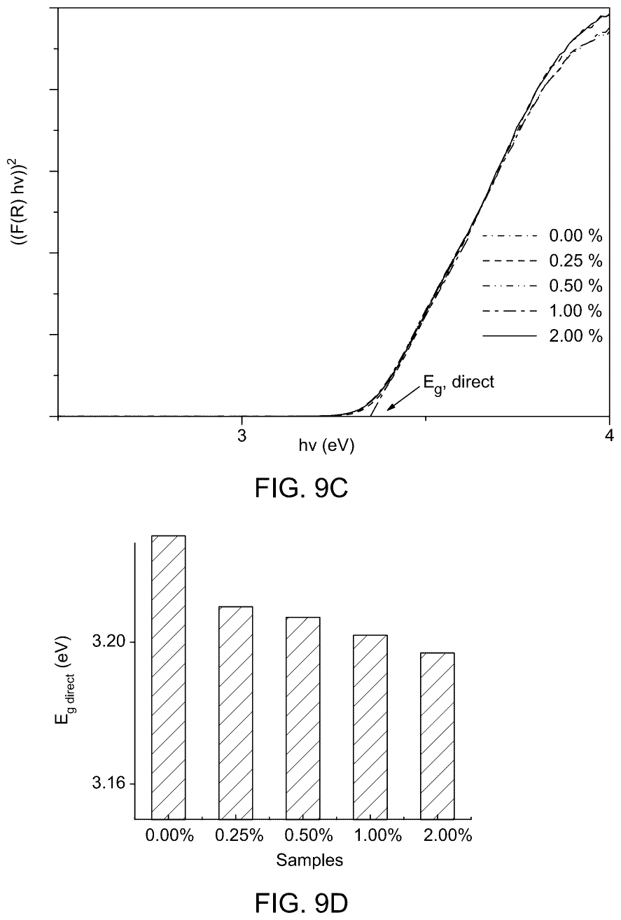

The bandgap is frequently determined by plotting [F(R)hν]² against hν and [F(R)hν]^{1/2} against hν for direct band gap and indirect band gap values, respectively. In anatase bulk TiO₂, the direct transition is prohibited, and an indirect bandgap is permitted. This bandgap is owing to the phonon-assisted electronic transition from O₂ₚ to Ti_{3d} in the M→Γ transition in the zone of Brillouin [C. H. Ho, M. C. Tsai, M. S. Wong, Characterization of indirect and direct interband transitions of anatase TiO2 by thermoreflectance spectroscopy, App. Phys. Lett. 93 (2008) 081904, incorporated herein by reference in its entirety]. Both direct and indirect bandgaps were considered and the variations in the bandgaps of TiO₂ with co-doping Sm and Ce ions were examined. [F(R)hν]^{1/2} was plotted against hν (FIG. 9A), and [F(R)hν]² was plotted against hν (FIG. 9C). The dashed lines drawn at the linear fragments of the curves at [F(R)hν]^{1/2}→0 and [F(R)hν]²→0 yield the values of indirect bandgap (E_{g indirect}) and direct bandgap (E_{g direct}), respectively. For all compositions, the magnitude of E_{g direct} (FIG. 9D) is higher than that of E_{g indirect} (FIG. 9B). The measured direct and indirect E_{g} values are 3.23 eV, and 3.16 eV, respectively, for pure TiO₂ nanoparticles. E_{g direct} values are slightly greater than that obtained in bulk TiO₂ (E_{g}=3.22 eV), while E_{g} values are lower than that obtained in the literature, where the authors obtained a value of 4.26 eV and 3.63 eV for direct and indirect bandgaps, respectively. However, a progressive reduction in both direct and indirect energy bandgaps of TiO₂ NPs was observed as the amount of Sm and Ce elements increased from 0.25 to 2.0%. Similar results were obtained in the case of TiO₂ co-doped with Ce—Nd elements in literature. On co-doping, the 4f levels of Ce and Sm rare earth can be introduced below the 3d level of Ti, permitting the electronic transition from O₂ₚ to Ce_{4f} and Sm_{4f} levels. This eventually led to the shifting in the edge of absorption to low energies and a narrowing in the bandgap value of the material. These analyses agree well with the theoretical results discussed above. According to these obtained results, it can be assumed that the cerium and samarium elements surrounding the TiO₂ granules can absorb a larger light radiation range and increase the visible light absorption capacity of the nanophotocatalysts.

### Photocatalytic Degradation Evaluation

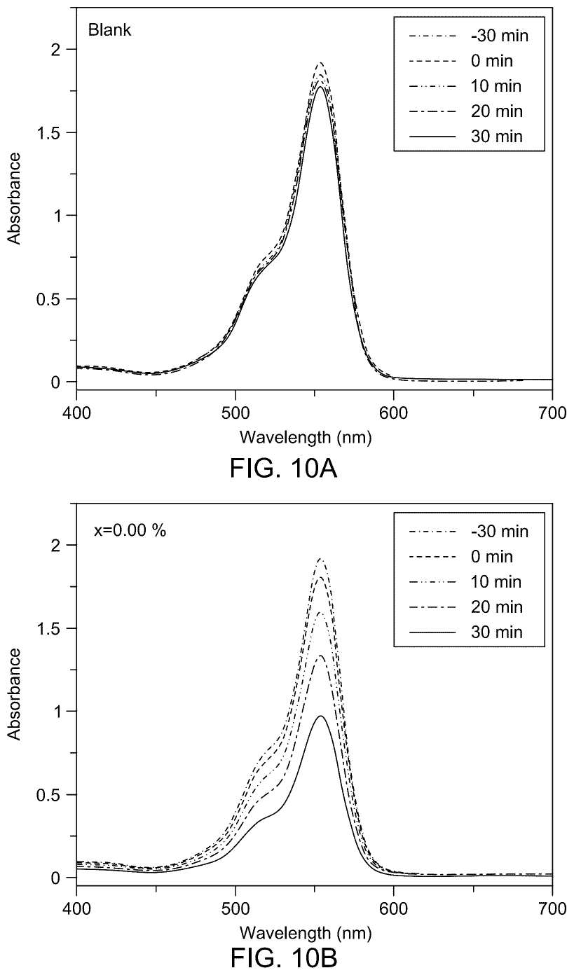

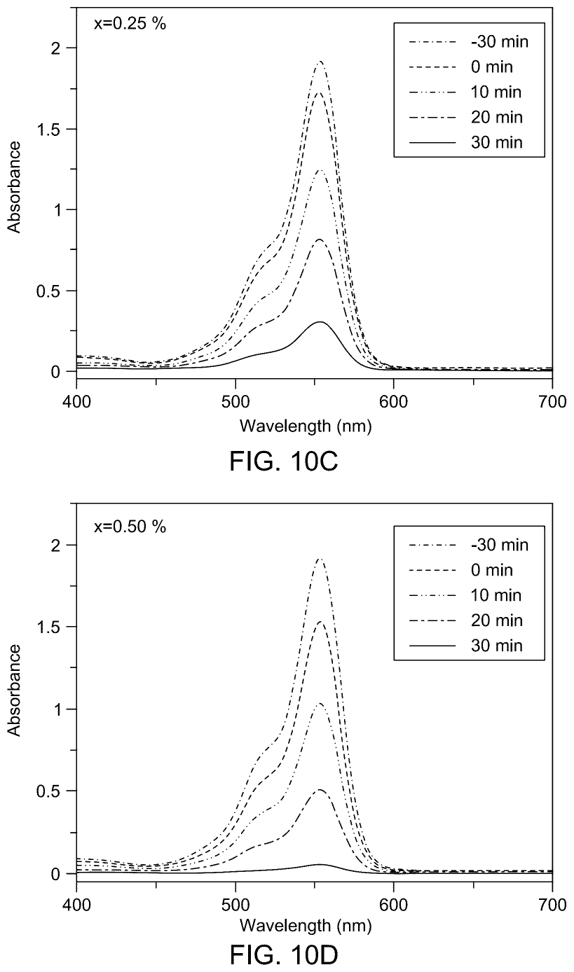

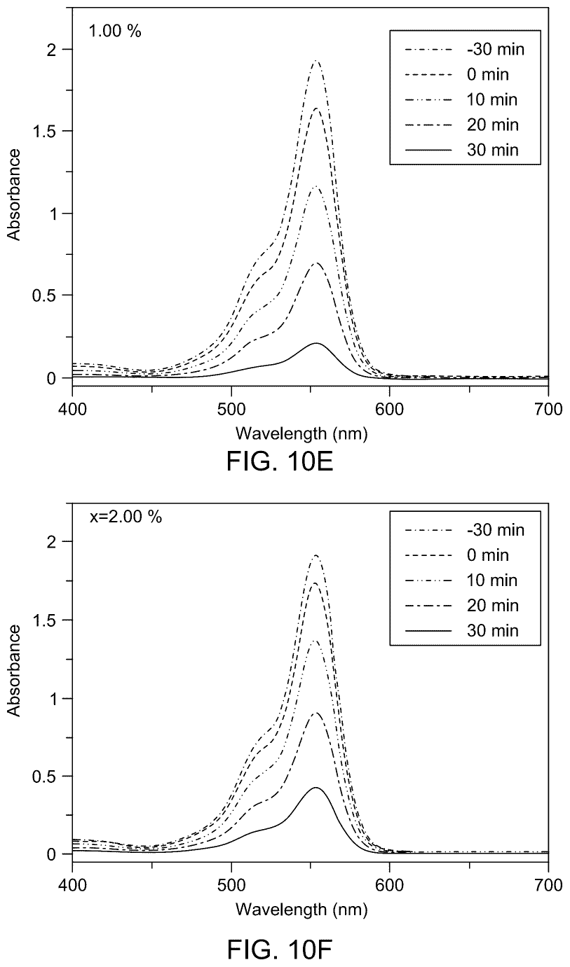

The photocatalytic features of Ce—Sm co-doped TiO₂ NPs (x=0.00, 0.25, 0.50, 1.00, and 2.00%) on the degradation of Rhodamine B (RB) dye as a pollutant were carried out under visible light radiation. As a tracking parameter, the temporal variations in the absorption peak with time −30, 0, 10, 20, and 30 minutes were investigated. FIGS. 10A-10F illustrate the absorption spectra of blank, pristine TiO₂ NPs, and Ce—Sm co-doped TiO₂ NPs as nanophotocatalysts. It is obvious that the degradation of RB dye without a catalyst in the solution is hardly degraded by solely visible light irradiation, as clearly seen in FIG. 10A. In the presence of NPs in the RB dye solution, the intensity of absorption peak progressively reduces under visible light irradiation, which indicates that the Ce—Sm co-doped TiO₂ NPs enhance the dye degradation. This demonstrates that the RB was demethylated via the demolition of the chromophore structure of the dye. The pristine TiO₂ NPs (FIG. 10B) showed a slight increase in the degradation of RB dye with a removable efficiency of about 50% after 30 minutes. However, the degradation of different samples of Ce—Sm co-doped TiO₂ NPs showed a gradual increase from x=0.00% until x=0.50%, then a gradual decrease at x=1.0% and x=2.0% compositions. This has occurred because, if dopant ion concentration exceeds 0.50%, the excess dopants can cover the surface of TiO₂, which leads to a decrease in the concentration of photogenerated charge carrier, and thus the photocatalytic activity decreases, as clear from FIGS. 10C-10F. The x=0.5% composition (FIG. 10D) showed the extreme absorption curve of RB dye solution with the lowest absorbance at the degradation time of 30 minutes, which indicates that the x=0.5% composition has a photocatalytic performance better than other ratios.

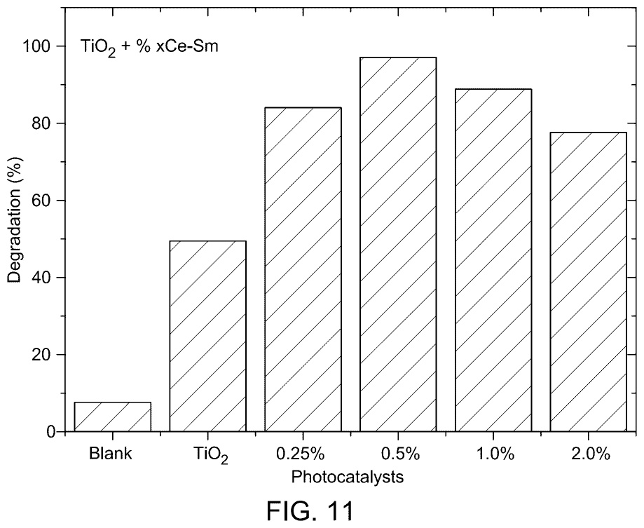

FIG. 11 presents the degradation percentage (%) of RB dye against the different concentrations of Ce—Sm co-dopants after 30 minutes of visible light illumination. It is evident that the presence of NPs helps in degrading the RB dye. The pristine TiO₂ NPs showed an RB dye degradation percent of about 50% after 30 minutes. The RB dye degradation percent increases gradually with rising the concentration of Ce—Sm co-dopants to reach degradation efficiency of about 85% and 98% for x=0.25% and 0.50%, respectively. With the further increase in the concentration of Ce—Sm co-dopants, the RB dye degradation percent decreases to about 90% and 79% for x=1.00% and 2.00%, respectively. The highest degradation efficiency was noted for TiO₂ nanoparticles co-doped with x=0.50% of Ce and Sm ions with 98% of decomposition. Hence, a concentration of Ce—Sm as co-dopants within the structure of TiO₂ NPs could enhance the photocatalytic activity against pollutants.

In Table 2, previous photocatalytic results reported for TiO₂-based materials in comparison with the present results are presented. As shown in this table, Ce—Sm co-doped TiO₂ NPs showed a greatly enhanced photocatalytic activity in comparison to other TiO₂-based compositions.

TABLE 2
List of photocatalytic TiO₂-based materials.

| | Irradiation | | Degradation | Duration | |
|---|---|---|---|---|---|
| Materials | source | Dyes | % | (min) | Reference |
| Ce—Sm co- | Xenon lamp | RB | 98 | 30 | Present |
| doped TiO₂ | (250 W, λ ≤ 400 | | | | disclosure |
| NPs | nm) | | | | |
| Ce-doped TiO₂ | UV light (15 W, | RB | 95 | 120 | [1] |
| nanosheets | 365 nm) | | | | |
| Mn-doped | Tungten halogen | Malachite | 96 | 105 | [2] |
| TiO₂ | lamp (300 W, | green (MG) | | | |
| | 500 nm) | | | | |
| Cobalt doped | Fluorescent lamp | Methyl | 34.7 | 360 | [3] |
| TiO₂ | (23 W, 6400K, | orange (MO) | | | |
| | 1311 Lumens) | | | | |
| Sm doped | UV light (365 | MO | 96 | 120 | [4] |
| TiO₂ NPs | nm) | | | | |
| Sm doped | UV source (125 | RB | 95.7 | 120 | [5] |
| TiO₂ NPs | W Hg lamp) | | | | |
| Er³⁺ doped | Xe lamp (400 W, | Phenol | 75 | 180 | [6] |
| TiO₂ NPs | λ > 450 nm) | | | | |
| Nd-doped TiO₂ | Xe lamp (350 W, | MO | 96.5 | 60 | [7] |
| NPs | λ > 420 nm) | | | | |
| La—Gd co- | Xe lamp (300 W, | MO | 97 | 150 | [8] |
| doped TiO₂ | PLS-SXE | | | | |
| hollow spheres | 300/300UV) | | | | |
| Na-doped TiO₂ | UV lamp (300 | Methylene | 92.5 | 60 | [9] |
| | W, 365 nm) | blue (MB) | | | |
| Gd-doped TiO₂ | UV source (500 | MO | 41 | 28 | [10] |
| films | W high-voltage | | | | |
| | mercury lamp) | | | | |

References (each incorporated herein by reference in its entirety):
[1] Z. Fan, F. Meng, J. Gong, H. Li, Z. Ding, B. Ding, One-step hydrothermal synthesis of mesoporous Ce-doped anatase TiO₂ nanoparticles with enhanced photocatalytic activity. J. Mater. Sci. Mater. Electron. 27 (2016) 11866-11872;
[2] S. P. Keerthana, R. Yuvakkumara, G. Ravi, A. G. Al-Sehemi, D. Velauthapillai, Investigation of optimum Mn dopant level on TiO₂ for dye degradation, Chemosphere 306 (2022) 135574;
[3] A. El Mragui, O. Zegaoui, J. C. G. Esteves da Silva, Elucidation of the photocatalytic degradation mechanism of an azo dye under visible light in the presence of cobalt doped TiO₂ nanomaterials, Chemosphere, 266 (2021) 128931;
[4] G. V. Khade, M. B. Suwarnkar, N. L. Gavade, K. M. Garadkar, Sol-gel microwave assisted synthesis of Sm-doped TiO₂ nanoparticles and their photocatalytic activity for the degradation of Methyl Orange under sunlight. J. Mater. Sci. Mater. Electron. 27 (2016) 6425-6432;
[5] S. E. Arasi, J. Madhavan, M. V. A. Raj, Effect of samarium (Sm³⁺) doping on structural, optical properties and photocatalytic activity of titanium dioxide nanoparticles, J. Taibah Univ. Sci. 12 (2018) 186-190;
[6] J. Reszczyńska, T. Grzyb, J. W. Sobczak, W. Lisowski, M. Gazda, B. Ohtani, A. Zaleska, A. Visible light activity of rare earth metal doped (Er3+, Yb3+ or Er3+/Yb3+) titania photocatalysts, Appl. Catal. B 163 (2015) 40-49;
[7] J. Liang, J. Wang, K. Song, X. Wang, K. Yu, C. Liang, Enhanced photocatalytic activities of Nd-doped TiO₂ under visible light using a facile sol-gel method, J. Rare Earths 38 (2020) 148-156;
[8] R. Bao, R. Li, C. Chen, H. Wu, J. Xia, C. Long, H. Li, Biotemplated synthesis of 3D rare earth-doped TiO₂ hollow spheres for photocatalytic application, J. Phys. Chem. Solids 126 (2019) 78-84;
[9] I. Singh, B. Birajdar, Synthesis, characterization and photocatalytic activity of mesoporous Na-doped TiO₂ nano-powder prepared via a solvent-controlled non-aqueous sol-gel route, RSC Adv. 7 (2017) 54053-54062;
[10] X. Q. Cheng, C. Y. Ma, X. Y. Yi, F. Yuan, Y. Xie, J. M. Hu, B. C. Hu, Q. Y. Zhang, Structural, morphological, optical and photocatalytic properties of Gd-doped TiO₂ films, Thin Solid Films 615 (2016) 13-18.

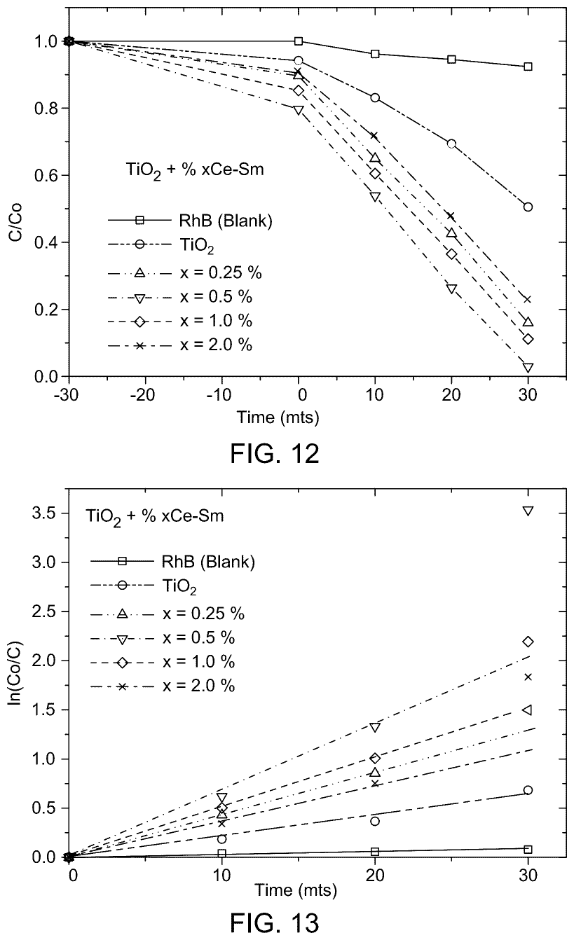

For further investigation, the percent degradation with time for all samples under UV-vis light was plotted, and the plots are shown in FIG. 12. The degradation rate of pristine TiO₂ NPs is slow because the band gap is broad to be excited by visible light. However, the degradation rates of Ce—Sm co-doped TiO₂ NPs are higher because of the inhibition of photogenerated electron-hole recombination. The improvement in the degradation rate speedily decreased for Ce—Sm co-doped TiO₂ NPs with x=0.50%.

The pseudo-first-order kinetics was applied to calculate the kinetics constant (k) values of Ce—Sm co-doped TiO₂ NPs (x=0.00, 0.25, 0.50, 1.0, and 2.0%). Accordingly, curves of ln(C₀/C) versus time were plotted (FIG. 13). The rate constants determined from the slope are used to evaluate the photocatalytic activity of prepared nanoparticles. The best-observed reaction rate constant is for Ce—Sm co-doped TiO₂ NPs with x=0.50% of about 0.0616 min⁻¹, which is almost four times greater than that of pure TiO₂ NPs as 0.0149 min⁻¹ after 30 minutes of visible light illumination. The other compositions revealed rate constants of about 0.0367 min⁻¹, 0.0434 min⁻¹, and 0.0303 min⁻¹ for x=0.25%, 1.00%, and 2.00%, respectively.

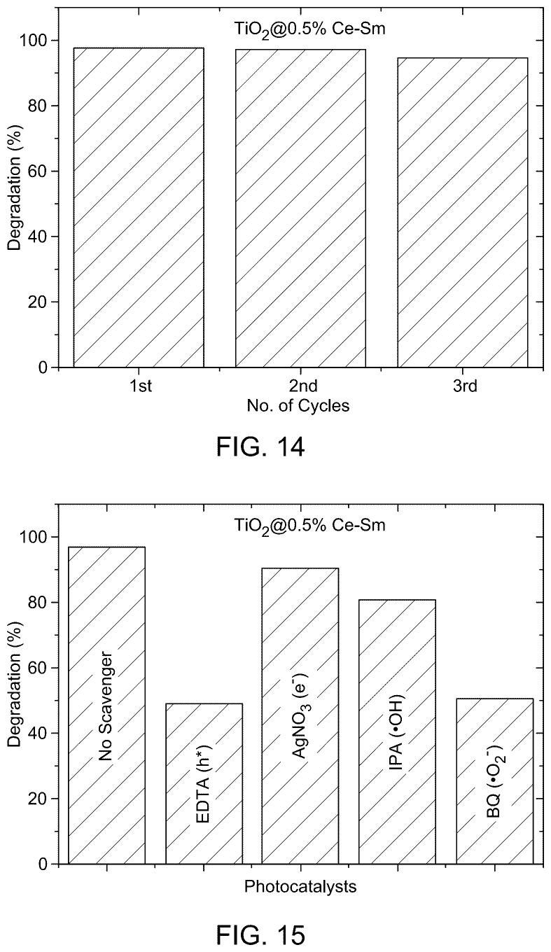

The reusability and stability of the Ce—Sm co-doped TiO₂ NPs are among the factors of nanophotocatalysts for the degradation of dyes. Accordingly, Ce—Sm co-doped TiO₂ NPs with x=0.50% were subjected to consecutive photocatalytic experiments against RB dye under the same starting conditions to verify their stability (FIG. 14). After each experiment, centrifugation was used to recover the nanoparticles, which was then dried in the oven and ground again using agate mortar. These experiments were repeated three times consecutively, and the RB dye photocatalytic percent is found to be higher than 94%, which is not drastically diminished as presented in FIG. 14. The obtained results show that the present nanophotocatalysts display great photocatalytic activities, are highly stable, easily recovered, and reused, indicating their potential for practical applications in the future.

The probable active species involved in the photocatalytic degradation process were examined by using various scavengers. In most cases, four active species are involved in the photocatalytic degradation process. These are ·O₂⁻, ·OH, e⁻, and holes (h⁺); various scavengers were introduced, correspondingly, in the photocatalytic degradation system, and other conditions were the same as indicated above. The scavengers are isopropanol, IPA (·OH scavenger), ethylenediaminetetraacetic acid, EDTA (h⁺ scavenger), 1,4-benzoquinone, BQ (·O₂⁻ scavenger), and silver nitrate, AgNO₃ (e⁻ scavenger). FIG. 15 shows that h⁺ and ·O₂⁻ play the largest roles in the degradation of RB since the inclusion of scavengers for these two active species reduces the degradation capacity. ·OH is also shown to be involved in the degradation, since the addition of IPA may also influence the degradation. Three highly oxidative species include h⁺, ·O₂⁻, and ·OH. According to these findings, their oxidative activities might be used to degrade RB in this photocatalysis process. It is worth noting that the addition of AgNO₃ can promote degradation. The reason is that AgNO₃ may consume e⁻ as an e⁻ scavenger, which reduces the recombination of electron-hole (e⁻-h⁺) pairs and enhance the photocatalytic activity.

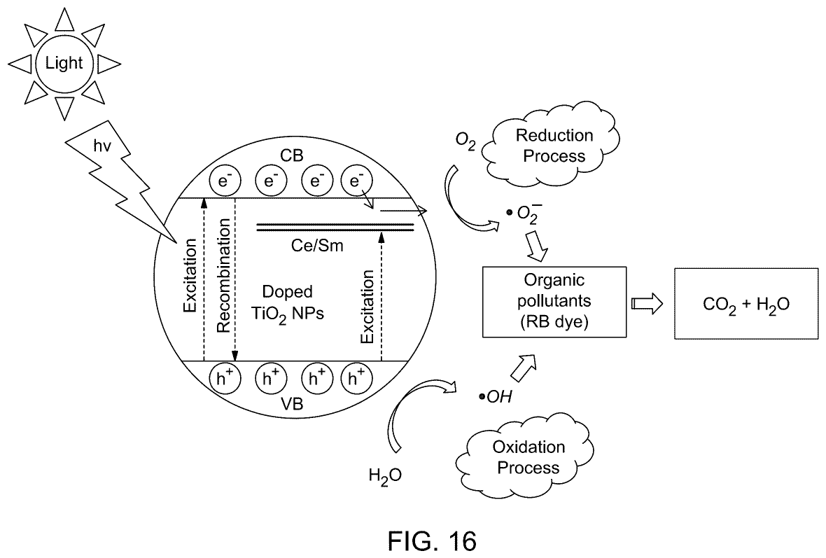

The mechanism can be described as shown in FIG. 16. Once the TiO₂ NPs are subjected to light illumination, the electrons (e⁻) within the valence band (VB) are excited to the conduction band (CB), generating electron-hole pairs (e⁻-h⁺). The electrons (e⁻) will react with the oxygen molecules (O₂) to generate superoxide radicals (·O₂⁻). The holes (h⁺) in VB can directly destroy RB molecules or mix with water molecules adsorbed on the surface of the nanophotocatalysts to create hydroxyl radicals (·OH). These hydroxyl radicals are effective oxidation agents that destroy organic pollutants. This procedure causes a photocatalytic oxidation of the organic pollutants with the subsequent steps: (a) adsorption of light by the nanophotocatalysts, (b) generation of e⁻-h⁺ pairs, (c) charge carriers' recombination, and (d) reactants' use of charge carriers. The boost in the photocatalytic activities of Ce—Sm co-doped TiO₂ NPs is mainly attributable to the dual inclusion of Ce⁴⁺ and Sm³⁺ cations and the defects generated in the TiO₂ anatase structure. Ce—Sm co-doped TiO₂ NPs would create large amounts of oxygen vacancies because of the existence of Ce⁴⁺ and Sm³⁺ ions. Hence, Ce⁴⁺ and Sm³⁺ ions can act as scavengers for electrons. They may generate interbond defects below the CB, acting as traps for the transition of electrons and therefore lowering the recombination process of e⁻-h⁺ pairs. Consequently, the photocatalytic efficiency of nanoparticles will be enhanced.

The photocatalytic efficiency is also dependent on the crystal structure of NPs, particle diameter distribution, and morphology. The photocatalytic activities of the present nanoparticles are influenced by many factors such as the preparation method of co-doped TiO₂ NPs by the sol-gel auto-combustion technique that can cause a high surface area and agglomerated nanosized particles, which could enhance the photocatalytic efficiency. Moreover, the dual doping of rare earths (Ce and Sm) has been discovered to be helpful in shifting the impurity states and boosting the 4f electrons interface between the TiO₂ intrinsic bands and impurity states, leading to a reduction in bandgap energy.

In the present disclosure, highly photocatalytic active Ce—Sm co-doped TiO₂ NPs (x=0.00, 0.25, 0.50, 1.00, and 2.00%) were synthesized through the sol-gel auto-combustion approach. The analyses by XRD, TEM, and elemental mapping techniques confirmed the development of spherical nanoparticles with tetragonal anatase TiO₂ structure and preferably an average crystallite size of 15.1 to 17.8 nm. A reduction in particle diameter is noticed upon the inclusion of Ce—Sm co-dopants. DFT calculations and UV-vis diffuse spectra showed a reduction in E_{g} values with Ce—Sm co-doping. The photocatalytic activities of the synthesized nanoparticles were assessed against RB dye. The exploration of absorbance results indicated that the different Ce—Sm co-doped TiO₂ nanoparticles display enhanced photocatalytic activities in comparison to pristine TiO₂ nanoparticles. The sample co-doped with an x content of 0.50% displayed the best photocatalytic activity among different prepared nanoparticles, where the photo-degradation efficiency reached about 98% within 30 minutes. Holes (h⁺) and ·O₂⁻ are the most involved active species in photocatalytic degradation, and ·OH is also involved in degradation. In addition to the photocatalytic activities, the present nanophotocatalysts are highly stable, easily recovered, and easily reused, indicating their potential for practical applications in the future.

Numerous modifications and variations of the present disclosure are possible in light of the above teachings. It is therefore to be understood that within the scope of the appended claims, the disclosure may be practiced otherwise than as specifically described herein.

1. A photocatalytic nanoparticle composition, comprising:
titanium dioxide nanoparticles comprising cerium and samarium;
wherein the titanium dioxide nanoparticles have a tetragonal anatase crystal phase;
wherein the cerium and the samarium are each present in the titanium dioxide nanoparticles in an amount of 0.1 to 0.4% by weight based on a total weight of the titanium dioxide nanoparticles;
wherein the titanium dioxide nanoparticles have an average crystallite size of 10 to 30 nanometers (nm); and
wherein the titanium dioxide nanoparticles have an average particle diameter of 10 to 50 nm.

2. The composition of claim 1, wherein the titanium dioxide nanoparticles comprise oxygen in an amount of 65 to 70 at. %, titanium in an amount of 30 to 35 at. %, cerium in an amount of 0.1 to 1.0 at. %, and samarium in an amount of 0.1 to 1.0 at. % based on a total atom count of the titanium dioxide nanoparticles.

3. The composition of claim 1, wherein the cerium and the samarium are each present in the titanium dioxide nanoparticles in an amount of 0.1 to 2.5% by weight based on the total weight of the titanium dioxide nanoparticles;
wherein the nanoparticle composition has an average crystallite size of 15 to 18 nm;
wherein the nanoparticle composition has an average particle diameter of 18 to 25 nm; and
wherein the titanium dioxide nanoparticles have a spherical shape.

4. The composition of claim 1, wherein the titanium dioxide nanoparticles have a cell volume of 136.00 to 137.00 cubic angstrom (Å³).

5. The composition of claim 1, wherein the cerium and the samarium displace the titanium in titanium dioxide crystallites in the titanium dioxide nanoparticles.

6. The composition of claim 1, wherein the titanium dioxide nanoparticles have an indirect bandgap (E_{g indirect}) from 3.05 to 3.15 electron volts (eV).

7. The composition of claim 6, wherein the indirect bandgap is calculated from a plot of a square root of a Kubelka-Munk function multiplied by an energy of a photon ([(F(R)hν)]^{1/2}) versus an energy of a photon (hν).

8. The composition of claim 1, wherein the titanium dioxide nanoparticles have a direct bandgap (E_{g direct}) from 3.15 to 3.25 eV.

9. The composition of claim 8, wherein the direct bandgap is calculated from a plot of a square of a Kubelka-Munk function multiplied by an energy of a photon ([(F(R)hν)]²) versus an energy of a photon (hν).

10. A method of degrading a dye, comprising:
contacting the photocatalytic nanoparticle composition of claim 1 with a dye solution comprising the dye to form a mixture; and
irradiating the mixture to degrade the dye in the dye solution.

11. The method of claim 10, wherein a reaction rate constant (k) under pseudo-first-order kinetics is from 0.0610 to 0.0620 per minute (min⁻¹), wherein the reaction rate corresponds to a concentration based on an absorption spectrum of the degradation of the dye solution at various times of the irradiating.

12. The method of claim 10, wherein the dye is a Rhodamine B dye.

13. The method of claim 10, wherein 97 to 99% of the dye in the dye solution is degraded during the irradiating, wherein the percent is a concentration based on an absorption spectrum of the dye solution before and after the irradiating.

14. The method of claim 10, wherein the irradiating is from 1 to 30 minutes.

15. The method of claim 10, wherein the irradiating includes irradiating the dye solution with light having a wavelength of 350 to 400 nm.

16. The method of claim 10, wherein the contacting and irradiating occur consecutively from 1 to 3 times and at least 94% of the dye in the dye solution is degraded, wherein the percent is a concentration based on an absorption spectrum of the dye solution before and after the irradiating.

17. The method of claim 10, further comprising:
adding one or more scavengers to the mixture,
wherein the scavenger is selected from the group consisting of isopropanol, ethylenediaminetetraacetic acid, a 1,4-benzoquinone, and silver nitrate.

18. The method of claim 17, wherein the mixture comprises ethylenediaminetetraacetic acid and 40 to 50% of the dye in the mixture is degraded during the irradiating, wherein the percent is a concentration based on an absorption spectrum of the dye solution before and after the irradiating, wherein the irradiating the mixture to degrade the dye in the dye solution forms holes in a valence band, wherein ethylenediaminetetraacetic acid scavenges and blocks the holes produced in the valence band.

19. The method of claim 17, wherein the mixture comprises 1,4-benzoquinone and 40 to 60% of the dye in the mixture is degraded during the irradiating, wherein the percent is a concentration based on an absorption spectrum of the dye solution before and after the irradiating, wherein the irradiating the mixture to degrade the dye in the dye solution forms superoxide (·O₂⁻), wherein the superoxide reacts with the dye.

20. The method of claim 17, wherein the mixture comprises silver nitrate and 85 to 95% of the dye in the mixture is degraded during the irradiating, wherein the percent is a concentration based on an absorption spectrum of the dye solution before and after the irradiating; and
wherein the mixture comprises isopropanol and 80 to 90% of the dye in the mixture is degraded during the irradiating, wherein the percent is a concentration based on an absorption spectrum of the dye solution before and after the irradiating.
